(19) United States
(12) Patent Application Publication
(10) Pub. No.: US 2019/0386389 A1
(43) Pub. Date: Dec. 19, 2019

(54) ANTENNA DEVICE, COMMUNICATION SYSTEM, AND ELECTRONIC APPARATUS

(71) Applicant: Murata Manufacturing Co., Ltd., Nagaokakyo-shi (JP)

(72) Inventor: Keiichi ICHIKAWA, Nagaokakyo-shi (JP)

(21) Appl. No.: 16/553,404

(22) Filed: Aug. 28, 2019

Related U.S. Application Data
(63) Continuation of application No. PCT/JP2019/008540, filed on Mar. 5, 2019.

(30) Foreign Application Priority Data
Mar. 13, 2018 (JP) 2018-045734

(51) Int. Cl. H01Q 1/36; H01Q 7/00; H04B 5/00

(52) U.S. Cl. CPC H01Q 1/36; H04B 5/0037; H01Q 7/00

(57) ABSTRACT

An antenna device includes a first and second coil conductors. The second coil conductor includes a first conductor portion and a second conductor portion. The first conductor portion is provided in an outer side portion relative to an outer circumference of the first coil conductor when viewed from a winding axis direction of the first coil conductor and surrounds a formation region of the first coil conductor. The second conductor portion is connected to the first conductor portion and includes a second aperture, at least a portion thereof is disposed in an outer side portion relative to the outermost circumference of the first coil conductor, and at least a portion of the second aperture is disposed in an outer side portion relative to the formation region of the first coil conductor. The second conductor portion includes a portion farther from the first coil conductor than the first conductor portion.

### CROSS REFERENCE TO RELATED APPLICATIONS

This application claims the benefit of priority to Japanese Patent Application No. 2018-045734 filed on Mar. 13, 2018 and is a Continuation Application of PCT Application No. PCT/JP2019/008540 filed on Mar. 5, 2019. The entire contents of each application are hereby incorporated herein by reference.

### BACKGROUND OF THE PRESENT INVENTION

### 1. Field of the Present Invention

The present invention relates to an antenna device, a communication system, and an electronic apparatus, and more particularly, to an antenna device including a plurality of coil conductors, a communication system including the antenna device, and an electronic apparatus including the antenna device.

### 2. Description of the Related Art

An existing antenna device including a plurality of coils has been known (see, for example, International Publication No. WO 2015/147133). The antenna device described in International Publication No. WO 2015/147133 includes a non-contact charging coil (first coil conductor) and a near field communication (NFC) coil (second coil conductor). The NFC coil is provided so as to surround the non-contact charging coil in an outer side portion relative to an outermost circumference of the non-contact charging coil.

In the existing antenna device described in International Publication No. WO 2015/147133, the second coil conductor is provided in the outer side portion relative to the outermost circumference of the first coil conductor. For example, when the existing antenna device is to be reduced in size, it is considered that a distance between the first coil conductor and the second coil conductor is shortened (the first coil conductor and the second coil conductor are closer to each other).

However, when the distance between the first coil conductor and the second coil conductor is shortened, magnetic field coupling between the first coil conductor and the second coil conductor becomes stronger, and mutual interference between the first coil conductor and the second coil conductor is increased.

### SUMMARY OF THE PRESENT INVENTION

Preferred embodiments of the present invention provide antenna devices, communication systems, and electronic apparatuses capable of reducing mutual interference between a first coil conductor and a second coil conductor.

An antenna device according to a preferred embodiment of the present invention includes a first coil conductor and a second coil conductor. The first coil conductor is for a first system and has a spiral shape. The second coil conductor is for a second system. The first coil conductor includes a first aperture. The second coil conductor includes a first conductor portion and a second conductor portion. The first conductor portion surrounds a formation region of the first coil conductor when viewed from a winding axis direction of the first coil conductor. The second conductor portion is connected to the first conductor portion and is wound so as to include a second aperture. At least a portion of the second conductor portion is disposed in an outer side portion relative to an outermost circumference of the first coil conductor when viewed from the winding axis direction of the first coil conductor. In the second conductor portion, at least a portion of the second aperture is disposed in an outer side portion relative to the formation region of the first coil conductor. The second conductor portion includes a portion farther from the first coil conductor than the first conductor portion.

A communication system according to a preferred embodiment of the present invention includes an antenna device according to a preferred embodiment of the present invention, a circuit for the first system, and a circuit for the second system.

An electronic apparatus according to a preferred embodiment of the present invention includes an antenna device according to a preferred embodiment of the present invention, a circuit substrate, and a housing. The circuit substrate includes a system circuit to operate the antenna device. The housing accommodates the antenna device and the circuit substrate.

With the antenna devices, the communication systems, and the electronic apparatuses according to preferred embodiments of the present invention, mutual interference between the first coil conductor and the second coil conductor is able to be reduced.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1A is a front view of an antenna device according to a first preferred embodiment of the present invention. FIG. 1B is a cross-sectional view of the antenna device according to the first preferred embodiment of the present invention when taken along a line X1-X1 in FIG. 1A.

FIG. 2 is a descriptive view for explaining a current flow in the antenna device according to the first preferred embodiment of the present invention.

FIG. 3 is a circuit diagram of the antenna device according to the first preferred embodiment of the present invention.

FIG. 4A is a cross-sectional view of an electronic apparatus according to the first preferred embodiment of the present invention. FIG. 4B is a cross-sectional view of the electronic apparatus according to the first preferred embodiment of the present invention when taken along a line Y1-Y1.

FIG. 5 is a front view of an antenna device according to a first variation of the first preferred embodiment of the present invention.

FIG. 6 is a front view of an antenna device according to a second variation of the first preferred embodiment of the present invention.

FIG. 7 is a front view of an antenna device according to a third variation of the first preferred embodiment of the present invention.

FIG. 8 is a front view of an antenna device according to a fourth variation of the first preferred embodiment of the present invention.

FIG. 9 is a front view of an antenna device according to a second preferred embodiment of the present invention.

FIG. 10 is a descriptive view for explaining a current flow in the antenna device according to the second preferred embodiment of the present invention.

FIG. 11A is a front view of an antenna device according to a third preferred embodiment of the present invention. FIG. 11B is cross-sectional view of the antenna device according to the third preferred embodiment of the present invention when taken along a line X2-X2 in FIG. 11A.

FIG. 12 is a front view of an antenna device according to a first variation of the third preferred embodiment of the present invention.

FIG. 13 is a front view of an antenna device according to a second variation of the third preferred embodiment of the present invention.

FIG. 14A is a front view of an antenna device according to a fourth preferred embodiment of the present invention. FIG. 14B is cross-sectional view of the antenna device according to the fourth preferred embodiment of the present invention when taken along a line X3-X3 in FIG. 14A.

FIG. 15 is a front view of an antenna device according to a fifth preferred embodiment of the present invention.

FIG. 16 is a descriptive view for explaining a current flow in the antenna device according to the fifth preferred embodiment of the present invention.

### DETAILED DESCRIPTION OF THE PREFERRED EMBODIMENTS

Hereinafter, antenna devices, communication systems, and electronic apparatuses according to preferred embodiments of the present invention will be described with reference to the drawings. It should be noted that as for components described in the specification and drawings, sizes, thicknesses, and dimensional relationships described in the specification and drawings are illustrative, and these components are not limited to examples described in the specification and drawings.

An “antenna device” according to each preferred embodiment is an antenna device that is used in a “wireless transmission system”. The “wireless transmission system” is a system for performing wireless transmission with a transmission partner (an antenna of an external apparatus) by magnetic field coupling. The “transmission” includes both of transmission and reception of signals and transmission and reception of electric power. The “wireless transmission system” includes both of a near field wireless communication system and a wireless power supply system. Since the antenna device performs the wireless transmission by the magnetic field coupling, the length of a current path of the antenna device, that is, the line lengths of coil conductors to be described later are sufficiently smaller than a wavelength λ at a frequency that is used in the wireless transmission and is preferably equal to or smaller than about λ/10, for example. Therefore, radiation efficiency of electromagnetic waves is low in a usage frequency band of the wireless transmission. Here, the wavelength λ is an effective wavelength in consideration of a wavelength shortening effect with a dielectric property and magnetic permeability of a base on which the coil conductors are provided. Both ends of the coil conductors are connected to a power supply circuit, and a current of a uniform or substantially uniform magnitude flows through the current path of the antenna device, i.e., the coil conductors.

Further, examples of the near field wireless communication that is used by the “antenna device” according to each preferred embodiment include a near field communication (NFC). A frequency band that is used for the near field wireless communication is, for example, an HF band, and is particularly a frequency band of 13.56 MHz and the vicinity thereof.

Examples of the wireless power supply method that is used by the “antenna device” according to each preferred embodiment include magnetic field coupling methods, such as an electromagnetic induction method and a magnetic field resonance method. Examples of wireless power supply standards for the electromagnetic induction method include the standard “Qi (registered trademark)” which is defined by Wireless Power Consortium (WPC). A frequency band that is used in the electromagnetic induction method is included in, for example, a frequency band in a range of equal to or higher than about 110 kHz and equal to or lower than about 205 kHz and in the vicinity of the above range. Examples of the wireless power supply standards for the magnetic field resonance method include the standard “AirFuel Resonant” which is defined by the AirFuel (registered trademark) Alliance. A frequency band that is used in the magnetic field resonance method is, for example, a 6.78 MHz-band or a 100 kHz-band.

The “antenna device” that is described in each preferred embodiment is mounted on an electronic apparatus and is preferably used for, for example, wireless charging (wireless power supply) and proximity wireless communication in the electronic apparatus.

The electronic apparatus including the “antenna device” that is described in each preferred embodiment is, for example, a cellular phone including a smartphone, a wearable apparatus, a wristwatch terminal, a headphone, or a hearing aid.

### First Preferred Embodiment

(1) Overall Configuration of Antenna Device

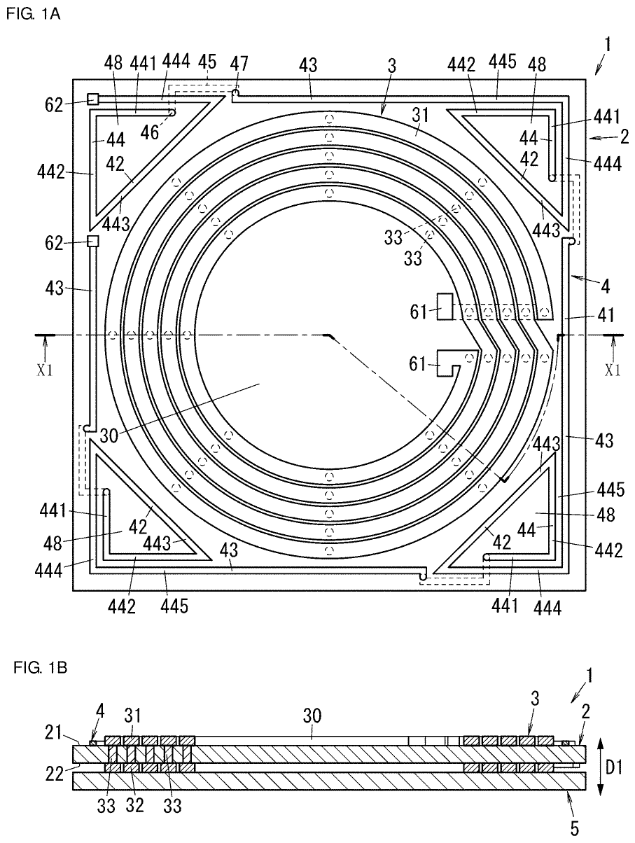

As illustrated in FIGS. 1A and 1B, an antenna device 1 according to the present preferred embodiment includes a first coil conductor 3 and a second coil conductor 4. The first coil conductor 3 has a spiral shape and is a coil conductor for a first system. The second coil conductor 4 is a coil conductor for a second system.

In the antenna device 1, the second coil conductor 4 includes a first conductor portion 41 and a plurality of (four in the drawing) second conductor portions 42. The first conductor portion 41 is provided in an outer side region relative to a formation region of the first coil conductor 3 when viewed from a first direction D1 (a winding axis direction of the first coil conductor 3). Each second conductor portion 42 is wound so as to include a conductor portion of the second coil conductor 4, which is the farthest from the first coil conductor 3, when viewed from the first direction D1 (the winding axis direction of the first coil conductor 3).

In addition, in the antenna device 1, the second coil conductor 4 is provided such that a direction of a current flowing through the first conductor portion 41 and a circulating direction of a current flowing through the second conductor portions 42 are the same when viewed from the first direction D1 (the winding axis direction of the first coil conductor 3). In other words, when the current flows, in a clockwise direction, through the second conductor portions 42, the current flows in the clockwise direction and also through a plurality of (for example, four in the drawing) conductor pieces 43 of the first conductor portion 41.

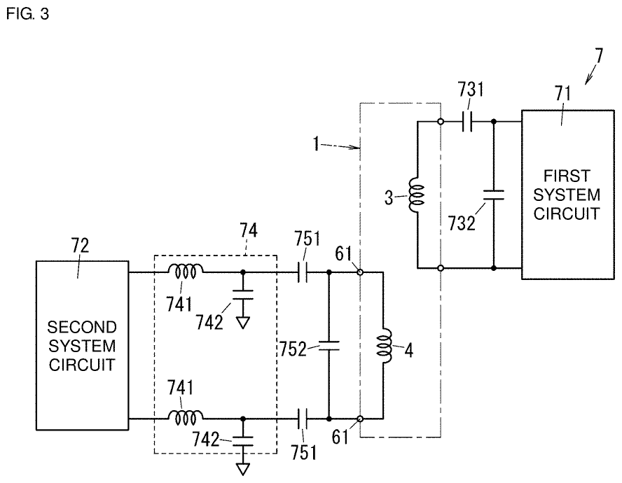

As illustrated in FIG. 3, the antenna device 1 is used together with a first system circuit 71 and a second system circuit 72. That is to say, the antenna device 1 is used for a communication system 7.

The communication system 7 includes the antenna device 1, the first system circuit 71, and the second system circuit 72. The communication system 7 further includes a plurality of (two in the drawing) capacitors 731 and 732, a filter 74, a plurality of (two in the drawing) series capacitors 751, and a parallel capacitor 752. The filter 74 includes a plurality of (two in the drawing) inductors 741 and a plurality of (two in the drawing) capacitors 742. Each inductor 741 is provided on a path connecting the second coil conductor 4 and the second system circuit 72. Each capacitor 742 is provided on a path between a node between the inductor 741 and the second coil conductor 4 on the above-described path and the ground.

(2) Components of Antenna Device

Next, components of the antenna device 1 according to the present preferred embodiment will be described with reference to the drawings. Here, the first direction D1 may be any of the winding axis direction of the first coil conductor 3, a winding axis direction of the second coil conductor 4, or a thickness direction of a base 2.

As illustrated in FIGS. 1A and 1B, the antenna device 1 includes the base 2, the first coil conductor 3, the second coil conductor 4, and a magnetic member 5.

(2.1) Base

As illustrated in FIGS. 1A and 1B, the base 2 preferably has a plate shape or a sheet shape and is made of an electrically insulating material, such as resin, for example, and includes a first main surface 21 and a second main surface 22 facing each other. Examples of the electrically insulating material used for the base 2 include polyimide, polyethylene terephthalate (PET), and liquid crystal polymer (LCP). The base 2 has a square or substantially square shape in a plan view from the thickness direction (first direction D1) of the base 2. The first coil conductor 3 and the second coil conductor 4 are provided on the base 2.

(2.2) First Coil Conductor

As illustrated in FIGS. 1A and 1B, the first coil conductor 3 is provided on the base 2 and is wound in the spiral shape. The first coil conductor 3 is the coil conductor for the first system. The first coil conductor 3 has an annular shape in a plan view from the first direction D1 and includes a first aperture 30. More specifically, the first coil conductor 3 includes a first coil conductor portion 31, a second coil conductor portion 32, and a plurality of via conductors 33. The plurality of via conductors 33 electrically connect the first coil conductor portion 31 and the second coil conductor portion 32. In other words, in order to reduce a resistance component of the first coil conductor 3, the first coil conductor portion 31 and the second coil conductor portion 32 are electrically connected to each other in parallel with the plurality of via conductors 33.

As illustrated in FIGS. 1A and 1B, the first coil conductor portion 31 has a spiral shape about an axis along the first direction D1. The first coil conductor portion 31 is preferably wound, for example, about five times. The first coil conductor portion 31 is preferably made of copper, aluminum, or the like, for example, and provided on the first main surface 21 of the base 2. For example, a copper film or an aluminum film may be provided on the first main surface 21 of the base 2 by etching or printing, such that the first coil conductor portion 31 is provided on the first main surface 21 of the base 2.

Similar to the first coil conductor portion 31, the second coil conductor portion 32 has a spiral shape about the axis along the first direction D1 as illustrated in FIGS. 1A and 1B. The second coil conductor portion 32 is preferably wound, for example, about five times. The second coil conductor portion 32 is preferably made of copper, aluminum, or the like, for example, and provided on the second main surface 22 of the base 2. For example, a copper film or an aluminum film may be provided on the second main surface 22 of the base 2 by etching or printing, such that the second coil conductor portion 32 is provided on the second main surface 22 of the base 2.

The coil conductor portions (the first coil conductor portion 31 and the second coil conductor portion 32) having the spiral shapes may be two-dimensional coil conductors that are wound a plurality of times in spiral shapes about the winding axis on one plane or may be three-dimensional coil conductors that are wound a plurality of times in helical shapes along the winding axis about the winding axis. FIGS. 1A and 1B illustrate the two-dimensional coil conductors. In the present application, the “formation region” of the coil conductor (the first coil conductor 3 or the second coil conductor 4) indicates a region surrounded by an innermost circumference of the coil conductor and an outermost circumference of the coil conductor. That is, the “formation region” of the coil conductor includes a region of a conductor portion (conducting wire) of the coil conductor and regions between portions of the conducting wire. Similarly, the “formation region” of the coil conductor portion (the first coil conductor portion 31 or the second coil conductor portion 32) indicates a region surrounded by an innermost circumference of the coil conductor portion and an outermost circumference of the coil conductor portion. That is, the “formation region” of the coil conductor portion includes a region of a conductor portion (conducting wire) of the coil conductor portion and a region between portions of the conducting wire.

The second coil conductor portion 32 is located at a position overlapping with the first coil conductor portion 31 in a plan view from the first direction D1. The second coil conductor portion 32 is provided along the first coil conductor portion 31 in a plan view from the first direction D1. In other words, the second coil conductor portion 32 does not intersect with the first coil conductor portion 31 but is provided such that a lengthwise direction of the second coil conductor portion 32 is along a lengthwise direction of the first coil conductor portion 31.

As described above, since the second coil conductor portion 32 overlaps with the first coil conductor portion 31, the first coil conductor 3 is prevented from being increased in size while increasing a size of the first aperture 30 surrounded by the first coil conductor portion 31 and the second coil conductor portion 32.

The plurality of via conductors 33 are connected in parallel between the first coil conductor portion 31 and the second coil conductor portion 32 and penetrates through the base 2. As illustrated in FIG. 1A, the plurality of via conductors 33 are provided at positions different from each other in a plan view from the first direction D1 and electrically connect the first coil conductor portion 31 and the second coil conductor portion 32 to each other. The plurality of via conductors 33 are provided at positions different from each other in the base 2.

The first coil conductor portion 31 and the second coil conductor portion 32 are electrically connected to each other with the plurality of via conductors 33. As a result, the current is able to flow in the first direction D1 while passing through the via conductors 33, so that a resistance component is smaller than that in the case where the coil conductor is defined only by the first coil conductor portion 31 or by the second coil conductor portion 32.

(2.3) Second Coil Conductor

As illustrated in FIGS. 1A and 1B, the second coil conductor 4 is provided around the first coil conductor 3 on the base 2. The second coil conductor 4 is the coil conductor for the second system. The second coil conductor 4 includes the first conductor portion 41 and the plurality of (four in the drawing) second conductor portions 42.

Similar to the first coil conductor 3, the second coil conductor 4 is preferably made of copper, aluminum, or the like, for example, and provided on the base 2. For example, a copper film or an aluminum film may be provided on the first main surface 21 and the second main surface 22 of the base 2 by etching or printing, such that the second coil conductor 4 is provided on the first main surface 21 and the second main surface 22 of the base 2.

The first conductor portion 41 is wound around in an outer side portion relative to the outermost circumference of the first coil conductor 3 when viewed from the first direction D1 (the winding axis direction of the second coil conductor 4). In other words, the first conductor portion 41 surrounds the formation region of the first coil conductor 3 when viewed from the first direction D1. That is, the first conductor portion 41 is disposed in the outer side portion relative to the outermost circumference of the first coil conductor 3 when viewed from the first direction D1. The first conductor portion 41 includes the plurality of (four in the drawing) conductor pieces 43. The four conductor pieces 43 of the first conductor portion 41 correspond to four sides of the base 2 in a one to one correspondence and are provided along corresponding sides.

In the second coil conductor 4, the plurality of conductor pieces 43 of the first conductor portion 41 and the plurality of second conductor portions 42 are alternately connected. That is, the plurality of conductor pieces 43 and the plurality of second conductor portions 42 are connected in the order of the conductor piece 43, the second conductor portion 42, the conductor piece 43, and the second conductor portion 42.

Each of the plurality of second conductor portions 42 is connected to the first conductor portion 41 and is wound around in the outer side portion relative to the outermost circumference of the first coil conductor 3 when viewed from the first direction D1. Each second conductor portion 42 includes a second aperture 48. Each second conductor portion 42 is provided on the base 2 such that an outer shape thereof is preferably a right-angled triangular shape in a plan view in the thickness direction (first direction D1) of the base 2. More specifically, each second conductor portion 42 is provided at a corner portion of the base 2. That is, each second conductor portion 42 is provided in a region where a distance between the outermost circumference of the first coil conductor 3 and an outer edge of the base 2 is relatively large, that is, in a relatively large region. The corner portion of the base 2 indicates a region closer to an apex than the center of the base 2 in a region between the center and the apex of the base 2.

The second conductor portions 42 include portions farther from the first coil conductor 3 than the first conductor portion 41. In other words, the second conductor portions 42 include portions with longer distances to the first coil conductor 3 than a distance between the first conductor portion 41 and the first coil conductor 3. That is, the distances between the portions of the second conductor portions 42 and the first coil conductor 3 are larger than the distance between the first conductor portion 41 and the first coil conductor 3.

Each second conductor portion 42 includes a first conductor portion 44, a second conductor portion 45, a third conductor portion 46, and a fourth conductor portion 47. The first conductor portion 44 is provided on the first main surface 21 of the base 2 so as to be wound at least once. The first conductor portion 44 includes a plurality of (four or five in the drawing) conductor pieces 441 to 445 and is wound at least once. The second conductor portion 45 is provided on the second main surface 22 of the base 2. The third conductor portion 46 is a via conductor penetrating through the base 2 and electrically connecting the first conductor portion 44 and the second conductor portion 45. The fourth conductor portion 47 is a via conductor penetrating through the base 2 and electrically connecting the second conductor portion 45 and the conductor piece 43 of the first conductor portion 41.

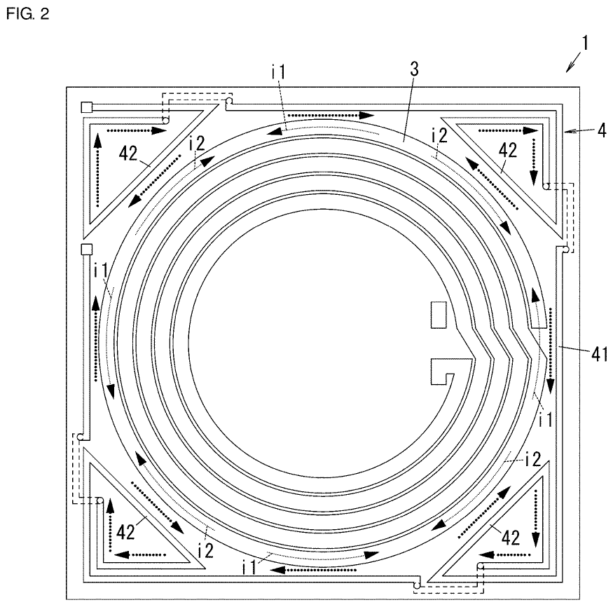

As illustrated in FIG. 2, the second coil conductor 4 is provided such that the circulating direction of the current flowing through the first conductor portion 41 about the center of gravity of the first aperture 30 and the circulating direction of the current flowing through each second conductor portion 42 about the center of gravity of the second aperture 48 are the same when viewed from the first direction D1 (the winding axis direction of the first coil conductor 3). In other words, when the current flows, in the clockwise direction, through the second conductor portions 42, the current also flows, in the clockwise direction, through the plurality of conductor pieces 43 of the first conductor portion 41.

First, the current flowing through the first conductor portion 41 of the second coil conductor 4 generates, in portions of the first coil conductor 3 which are close to the first conductor portion 41, a first induced current i1 in the opposite direction to that of the current flowing through the first conductor portion 41. On the other hand, by disposing the second conductor portions 42 of the second coil conductor 4 close to the first coil conductor 3, a second induced current i2 in the opposite direction to that of the current flowing through the second conductor portions 42 is generated in portions of the first coil conductor 3, which are close to the second conductor portions 42. When the first induced current i1 is a current flowing in the counterclockwise direction, the second induced current i2 is a current flowing in the clockwise direction. Therefore, in the first coil conductor 3, the first induced current i1 that is generated in the portions thereof, which are close to the first conductor portion 41, and the second induced current i2 that is generated in the portions thereof, which are close to the second conductor portions 42, cancel each other. The total sum of the currents flowing through the first coil conductor 3 is thus lower than that in the case where the second conductor portions 42 are not provided. As a result, it is possible to weaken the magnetic field coupling between the first coil conductor 3 and the second coil conductor 4.

With the above configuration, even when a gap between the first coil conductor 3 and the second coil conductor 4 is decreased, mutual interference between the first coil conductor 3 and the second coil conductor 4 is able to be reduced. Further, the antenna device 1 is able to be reduced in size.

(2.4) First Connection Terminal and Second Connection Terminal

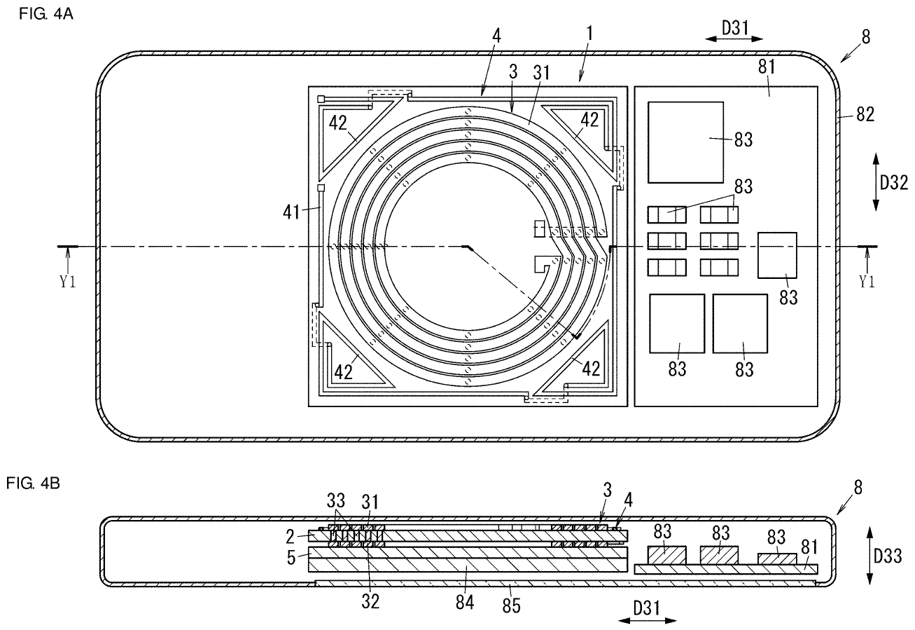

As illustrated in FIG. 1A, two first connection terminals 61 are provided on the base 2 to electrically connect a circuit substrate 81 (see FIG. 4A) of an electronic apparatus 8 and the first coil conductor 3. Two second connection terminals 62 are provided on the base 2 to electrically connect the circuit substrate 81 and the second coil conductor 4.

(2.5) First Protective Layer and Second Protective Layer

A first protective layer (not illustrated) covers the first coil conductor portion 31 of the first coil conductor 3 and the second coil conductor 4 provided on the first main surface 21 of the base 2 illustrated in FIG. 1B and protects the first coil conductor portion 31 and the second coil conductor 4 from external force and the like. The first protective layer preferably has a plate shape or a sheet shape and is made of an electrically insulating material, such as resin, for example. In a plan view from the first direction D1, a planar shape of the first protective layer is preferably the same or substantially the same shape as that of the base 2. The first protective layer is attached to the first main surface 21 of the base 2 with an adhesive layer (not illustrated) interposed therebetween.

A second protective layer (not illustrated) covers the second coil conductor portion 32 provided on the second main surface 22 of the base 2 illustrated in FIG. 1B and protects the second coil conductor portion 32 from external force and the like. Similar to the first protective layer, the second protective layer preferably has a plate shape or a sheet shape and is made of an electrically insulating material, such as resin, for example. In a plan view from the first direction D1, a planar shape of the second protective layer is preferably or substantially the same shape as that of the base 2. The second protective layer is attached to the second main surface 22 of the base 2 with an adhesive layer (not illustrated) interposed therebetween.

(2.6) Magnetic Member

As illustrated in FIG. 1B, at least a portion of the magnetic member 5 overlaps with the formation region of the first coil conductor 3 when viewed from the first direction D1 (the winding axis direction of the first coil conductor 3). The magnetic member 5 preferably has a square plate shape or a square sheet shape and is made of a ferromagnetic material, such as ferrite, for example. The magnetic member 5 has magnetic permeability higher than that of the base 2. Examples of the ferromagnetic material used for the magnetic member 5 include Ni—Zn—Cu based ferrite, Mn—Zn—Fe based ferrite, and hexagonal based ferrite. The magnetic member 5 is closer to the second coil conductor portion 32 than to the first coil conductor portion 31.

(3) Communication System

As illustrated in FIG. 3, the communication system 7 includes the antenna device 1, the first system circuit 71, and the second system circuit 72. The first system circuit 71 is a circuit to perform wireless communication using a first communication frequency as a carrier frequency. The second system circuit 72 is a circuit to perform wireless communication using a second communication frequency as a carrier frequency. In the example illustrated in FIG. 3, the first system circuit 71 is preferably a wireless charging system to perform wireless charging using the first coil conductor 3 for wireless charging. The second system circuit 72 is preferably a proximity wireless communication system to perform proximity wireless communication using the second coil conductor 4 for proximity wireless communication.

(4) Electronic Apparatus

As illustrated in FIGS. 4A and 4B, the electronic apparatus 8 includes the antenna device 1, a circuit substrate 81, and a housing 82. The electronic apparatus 8 is preferably, for example, a cellular phone including a smartphone, a wearable device, a wristwatch-type terminal, a headphone, or a hearing aid. The circuit substrate 81 includes a system circuit to operate the antenna device 1. The housing 82 accommodates therein the antenna device 1 and the circuit substrate 81. The housing 82 preferably has a rectangular or substantially rectangular parallelepiped shape and has a longitudinal direction D31 and a short-side direction D32. Further, the electronic apparatus 8 includes a plurality of circuit elements 83 provided on the circuit substrate 81, a battery 84 to drive the electronic apparatus 8, and a display device 85 to display predetermined information. The antenna device is accommodated in the housing 82 such that the thickness direction of the base 2 is along a height direction D33 of the housing 82.

(5) Advantageous Effects

As described above, in the antenna device 1 according to the first preferred embodiment, the second conductor portions 42 of the second coil conductor 4 are wound around in the outer side portions relative to the outermost circumference of the first coil conductor 3. The second coil conductor 4 is provided such that the direction of the current flowing through the first conductor portion 41 and the circulating direction of the current flowing through the second conductor portions 42 are the same direction. The magnetic field coupling between the first coil conductor 3 and the second coil conductor 4 is therefore able to be weakened, so that the mutual interference between the first coil conductor 3 and the second coil conductor 4 is reduced.

The antenna device 1 according to the first preferred embodiment includes the magnetic member 5 at least a portion of which overlaps with the formation region of the first coil conductor 3 when viewed from the first direction D1 (the winding axis direction of the first coil conductor 3). Desired inductance is therefore able to be obtained.

(6) Variations

Variations of the first preferred embodiment will be described below.

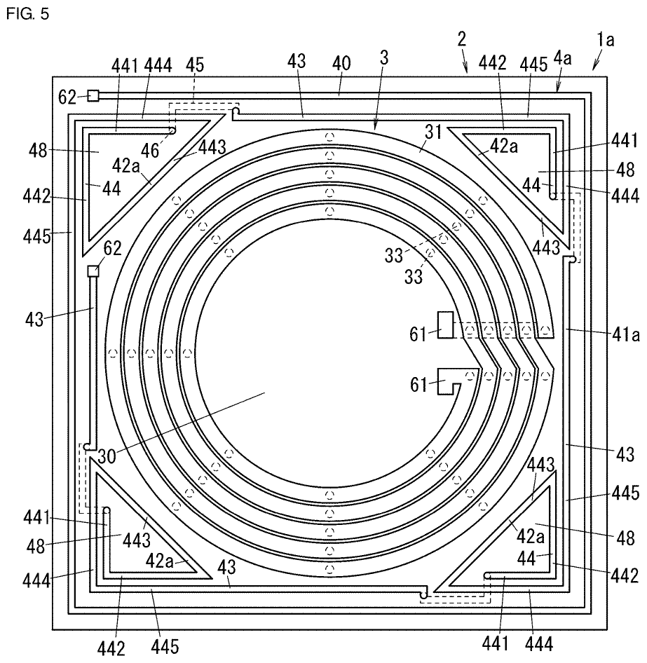

As a first variation of the first preferred embodiment, an antenna device 1a may include a second coil conductor 4a as illustrated in FIG. 5. The second coil conductor 4a includes a first conductor portion 41a, a plurality of (four in the drawing) second conductor portions 42a, and a fourth conductor portion 40 instead of the first conductor portion 41 and the plurality of second conductor portions 42. Each second conductor portion 42a is preferably wound about twice. As illustrated in FIG. 5, the fourth conductor portion 40 may be disposed in an outer side portion relative to the first conductor portion 41a and the plurality of second conductor portions 42a.

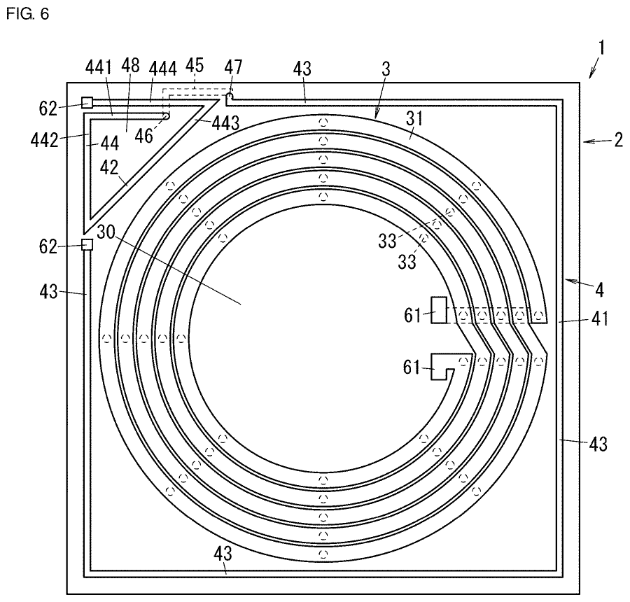

As a second variation of the first preferred embodiment, only one second conductor portion 42 may be provided as illustrated in FIG. 6. In short, it is sufficient that at least one second conductor portion 42 is provided.

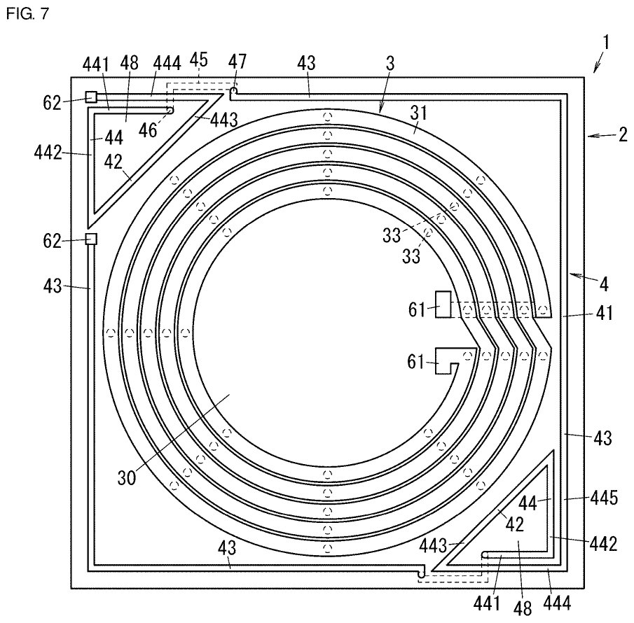

As a third variation of the first preferred embodiment, two second conductor portions 42 may be provided at symmetrical positions as illustrated in FIG. 7. More specifically, the two second conductor portions 42 illustrated in FIG. 7 are provided at point symmetrical positions with respect to the center of gravity (center) of the first coil conductor 3 as a symmetrical point. By providing the second conductor portions 42 at the symmetrical positions, it is possible to improve the symmetry of antenna characteristics of the second coil conductor 4.

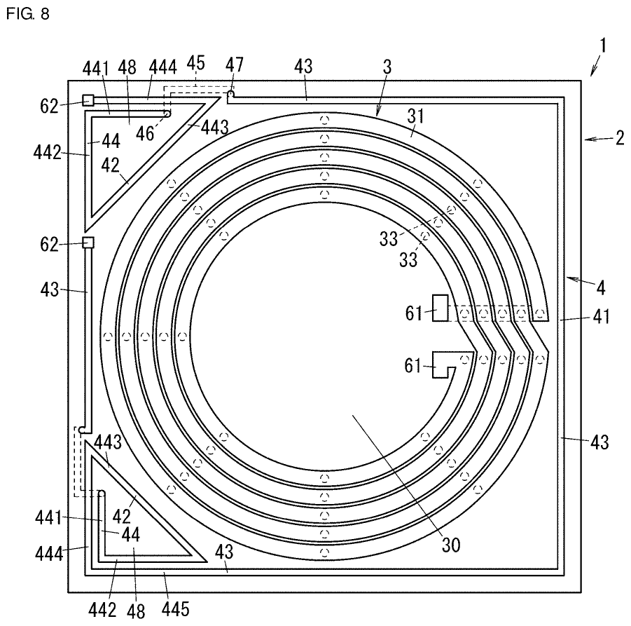

As a fourth variation of the first preferred embodiment, two second conductor portions 42 may be provided at symmetrical positions as illustrated in FIG. 8. As illustrated in FIG. 8, the two second conductor portions 42 may be provided on only one side. More specifically, the two second conductor portions 42 illustrated in FIG. 8 are provided at linearly symmetrical positions with respect to a straight line passing through the center of gravity of the first coil conductor 3 as a symmetry axis as illustrated in FIG. 8.

The numbers of turns of the plurality of second conductor portions 42 may be different from each other. Since the numbers of turns of the second conductor portions 42 are different from each other, directivity of antenna characteristics of the second coil conductor 4 is able to be changed. As a result, when there is a metal component around the second coil conductor 4, influences of the metal component on the second coil conductor 4 are able to be avoided.

The areas of the formation regions of the plurality of second conductor portions 42 may be different from each other. When the areas of the formation regions of the second conductor portions 42 are different from each other, it is possible to change directivity of the antenna characteristics of the second coil conductor 4.

The areas of the formation regions of the plurality of second conductor portions 42 may be the same as each other. Thus, magnetic field distribution is able to be made symmetrical.

The antenna devices according to each of the above variations also provides the same or substantially the same advantageous effects as those provided by the antenna device 1 according to the first preferred embodiment.

### Second Preferred Embodiment

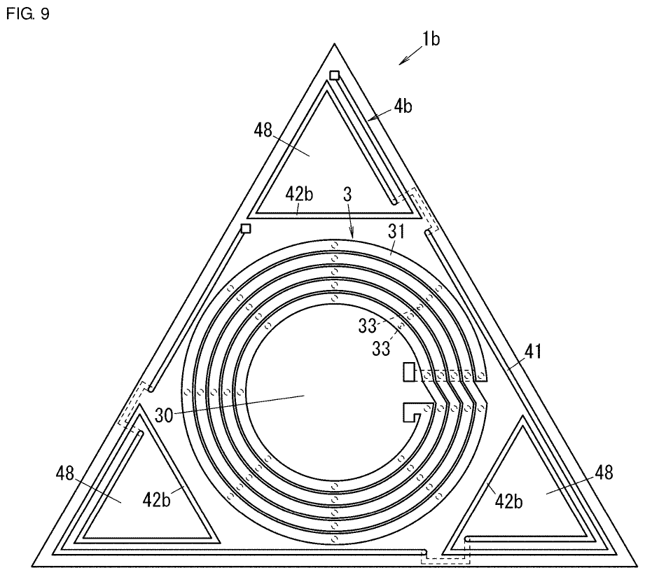

An antenna device 1b according to a second preferred embodiment of the present invention is different from the antenna device 1 (see FIG. 1A) according to the first preferred embodiment in that it has a triangular or substantially triangular shape as illustrated in FIG. 9. In the antenna device 1b according to the second preferred embodiment, the same or corresponding elements as those of the antenna device 1 according to the first preferred embodiment are denoted by the same reference numerals, and description thereof will not be repeated.

As illustrated in FIG. 9, the antenna device 1b includes a second coil conductor 4b instead of the second coil conductor 4. The second coil conductor 4b includes the first conductor portion and a plurality of (three in the drawing) second conductor portions 42b. Each second conductor portion 42b includes the second aperture 48, similar to each second conductor portion 42 (see FIG. 1A).

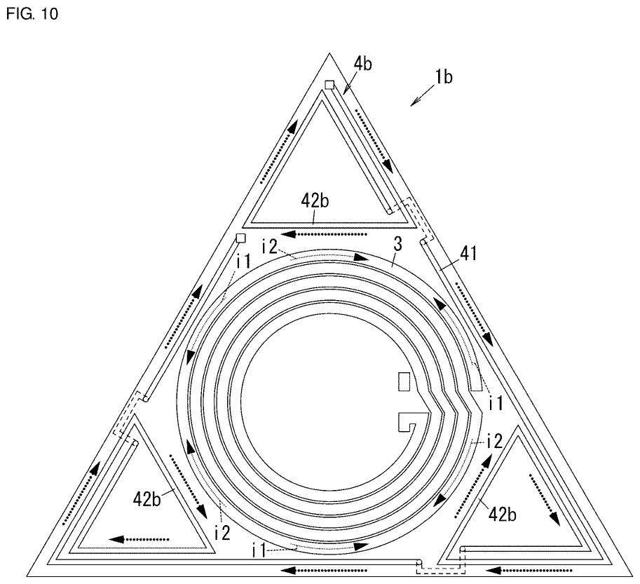

Generation of induced currents in the antenna device 1b according to the second preferred embodiment will be described with reference to FIG. 10.

First, a current flowing through the first conductor portion 41 of the second coil conductor 4b generates, in portions of the first coil conductor 3, which are close to the first conductor portion 41, a first induced current i1 in the opposite direction to that of the current flowing through the first conductor portion 41. On the other hand, by disposing the three second conductor portions 42b of the second coil conductor 4b close to the first coil conductor 3, a second induced current i2 in the opposite direction to that of the current flowing through the second conductor portions 42b is generated in portions of the first coil conductor 3, which are close to the second conductor portions 42b. When the first induced current i1 is a current flowing in the counterclockwise direction, the second induced current i2 is a current flowing in the clockwise direction. Therefore, in the first coil conductor 3, the first induced current i1 that is generated in the portions thereof, which are close to the first conductor portion 41, and the second induced current i2 that is generated in the portions thereof, which are close to the second conductor portion 42b, cancel each other. The total sum of the currents flowing through the first coil conductor 3 is thus reduced rather than that in the case where the second conductor portions 42b are not provided. As a result, it is possible to weaken magnetic field coupling between the first coil conductor 3 and the second coil conductor 4b.

With the above configuration, even when a gap between the first coil conductor 3 and the second coil conductor 4b is decreased, mutual interference between the first coil conductor 3 and the second coil conductor 4b is able to be reduced, thus reducing the antenna device 1b in size.

As for applications of the antenna device 1b according to the second preferred embodiment, the antenna device 1b is used in the electronic apparatus 8 similar to the antenna device 1 according to the first preferred embodiment.

As described above, the antenna device 1b according to the second preferred embodiment also provides the same or substantially the same advantageous effects as those provided by the antenna device 1 according to the first preferred embodiment.

### Third Preferred Embodiment

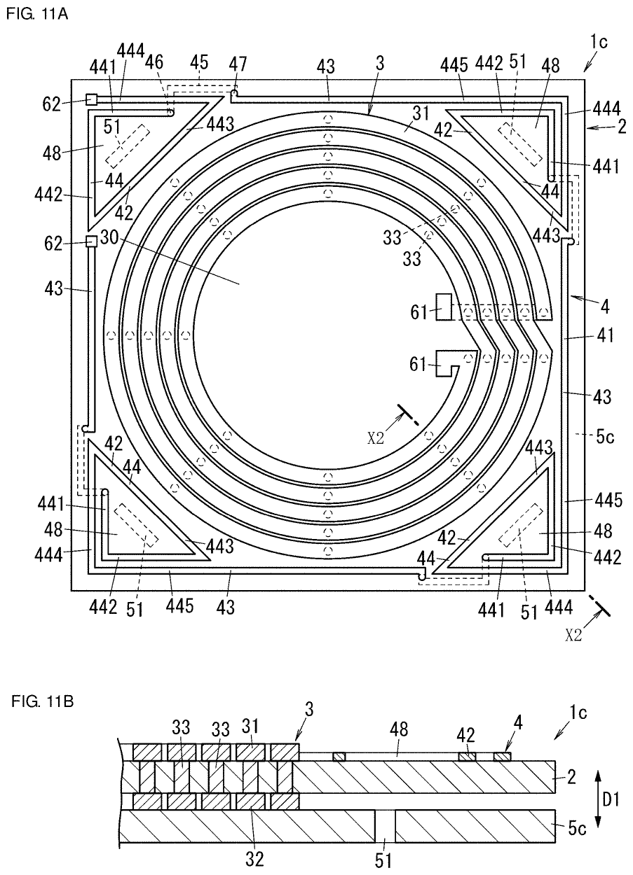

An antenna device 1c according to a third preferred embodiment of the present invention is different from the antenna device 1 (see FIG. 1A) according to the first preferred embodiment in that a plurality of (four in the drawing) slits 51 (through-holes) are provided in a magnetic member 5c, as illustrated in FIGS. 11A and 11B (a cross-sectional view taken along a line X2-X2 in FIG. 11A). In the antenna device 1c according to the third preferred embodiment, the same or corresponding elements as those of the antenna device 1 according to the first preferred embodiment are denoted by the same reference numerals, and description thereof will not be repeated.

As illustrated in FIGS. 11A and 11B, the magnetic member 5c includes the plurality of (for example, four in the drawing) slits 51. The plurality of slits 51 correspond to the plurality of second conductor portions 42 of the second coil conductor 4 in a one to one correspondence. Each slit 51 is provided in the second aperture 48 of the corresponding second conductor portion when viewed from the first direction D1 (the winding axis direction of the first coil conductor 3). That is, at least portions (portions of the slits 51) of the magnetic member 5c do not overlap with the second apertures 48 when viewed from the first direction D1 (the winding axis direction of the first coil conductor 3). Structures and functions of the magnetic member 5c in the third preferred embodiment, which are the same or substantially the same as those of the magnetic member 5 (see FIG. 1A) in the first preferred embodiment, will not be described.

As for applications of the antenna device 1c according to the third preferred embodiment, the antenna device 1c is used in the electronic apparatus 8 similar to the antenna device 1 according to the first preferred embodiment.

As described above, in the antenna device 1c according to the third preferred embodiment, when at least portions of the magnetic member 5c do not overlap with the second apertures 48 of the second conductor portions 42, magnetic fluxes generated by a current flowing through the second conductor portions 42 become easy to pass through the second apertures 48. Specifically, the magnetic fluxes generated by the current flowing through the second conductor portions 42 easily pass through the slits 51 to the second apertures 48. As a result, magnetic field coupling between the second conductor portions 42 and the first coil conductor 3 in the vicinity of the second conductor portions 42 becomes strong, and an induced current in the opposite direction, which flows through the first coil conductor 3 in the vicinity of the second conductor portions 42, is increased. Thus, the total sum of the induced currents flowing through the first coil conductor is reduced, so that the magnetic field coupling between the first coil conductor 3 and the second coil conductor 4 is able to be further reduced. As a result, the antenna device 1c is able to be further reduced in size.

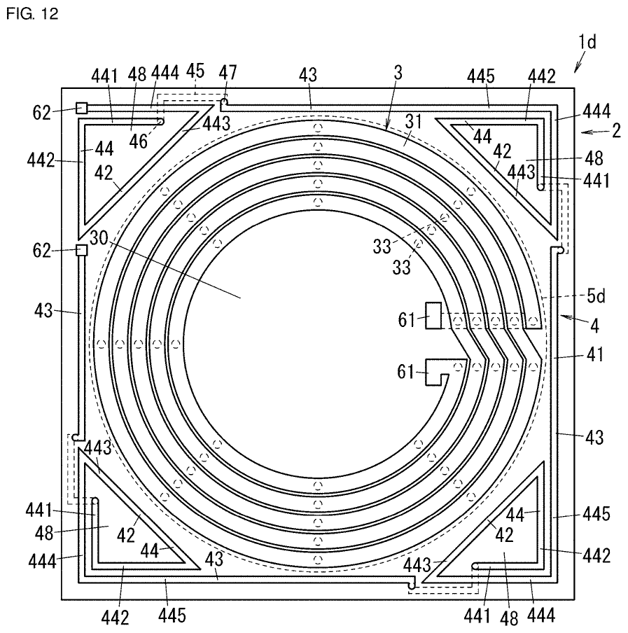

As a first variation of the third preferred embodiment, an antenna device 1d may include a magnetic member 5d which does not overlap with the second apertures 48 of the second conductor portions 42, as illustrated in FIG. 12.

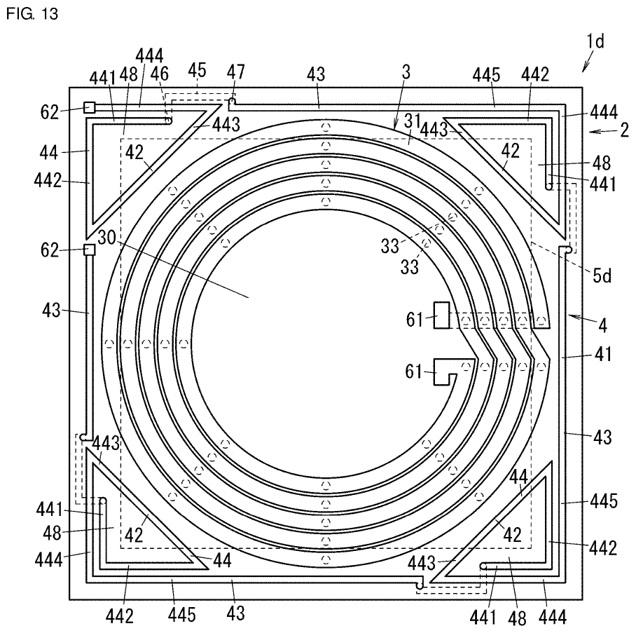

As a second variation of the third preferred embodiment, the antenna device 1d may include the magnetic member 5d which does not overlap with portions in the second apertures 48 of the second conductor portions 42, as illustrated in FIG. 13. The magnetic member 5d in the second variation covers not all but only a portion of the first coil conductor 3. In the second variation, there are regions in which no magnetic member 5d is provided in portions of the second apertures 48.

The antenna device 1d according to each of the first and second variations also provides the same or substantially advantageous effects as those provided by the antenna device 1c according to the third preferred embodiment.

### Fourth Preferred Embodiment

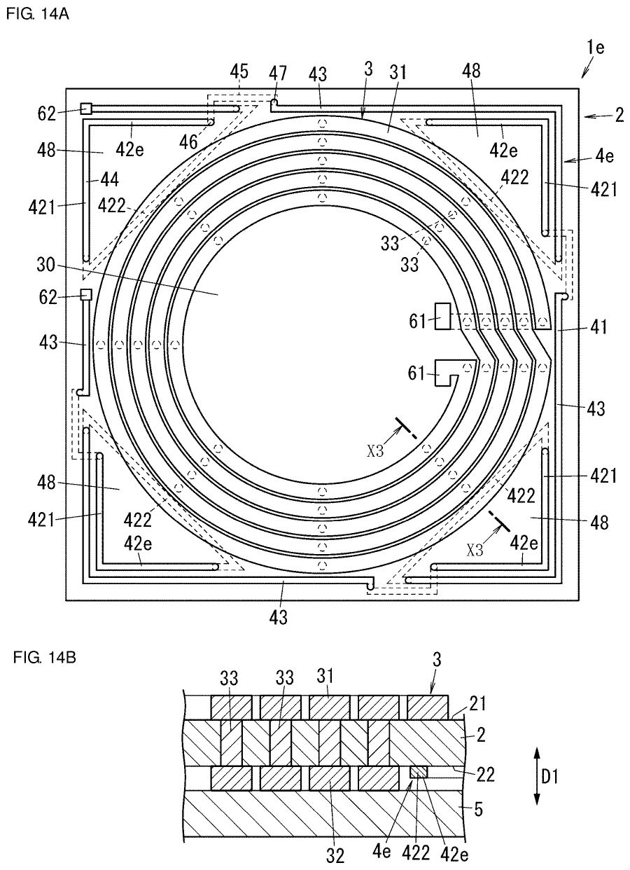

An antenna device 1e according to a fourth preferred embodiment of the present invention is different from the antenna device 1 (see FIG. 1A) according to the first preferred embodiment in that a portion of the first coil conductor 3 overlaps with a second coil conductor 4e, as illustrated in FIGS. 14A and 14B (a cross-sectional view taken along a line X3-X3 in FIG. 14A). In the antenna device 1e according to the fourth preferred embodiment, the same or corresponding elements as those of the antenna device 1 according to the first preferred embodiment are denoted by the same reference numerals, and description thereof will not be repeated.

As illustrated in FIGS. 14A and 14B, the antenna device 1e according to the fourth preferred embodiment includes the second coil conductor 4e instead of the second coil conductor 4. The second coil conductor 4e includes a plurality of (four in the drawing) second conductor portions 42e instead of the plurality of second conductor portions 42. Structures and functions of the second coil conductor 4e in the fourth preferred embodiment, which are the same or substantially the same as those of the second coil conductor 4 (see FIG. 1A) in the first preferred embodiment, will not be described.

Each of the plurality of second conductor portions 42e includes a portion 421 provided on the first main surface 21 of the base 2 and a portion 422 provided on the second main surface 22. A portion of each second conductor portion 42e overlaps with the first coil conductor 3. That is, each second conductor portion 42e includes a portion overlapping with the first coil conductor when viewed from the first direction D1 (the winding axis direction of the first coil conductor 3). In the example illustrated in FIG. 14A, a portion of the portion 422 of each second conductor portion 42e overlaps with the first coil conductor 3 when viewed from the first direction D1.

As described above, the second conductor portions 42e include the portions 421 provided on the first main surface 21 of the base 2 and the portions 422 provided on the second main surface 22. For this reason, the second conductor portions 42e are slightly inclined from the first direction D1 (the winding axis direction of the first coil conductor 3). The degree of inclination is preferably in a range of greater than about 0° and less than about 10°, for example.

As for applications of the antenna device 1e according to the fourth preferred embodiment, the antenna device 1e is used in the electronic apparatus 8 similar to the antenna device 1 according to the first preferred embodiment.

As described above, in the antenna device 1e according to the fourth preferred embodiment, mutual interference between the first coil conductor 3 and the second coil conductor 4e is able to be reduced. A gap between the first coil conductor 3 and the second coil conductor 4e is thus able to be decreased. As a result, the antenna device 1e is able to be further reduced in size.

### Fifth Preferred Embodiment

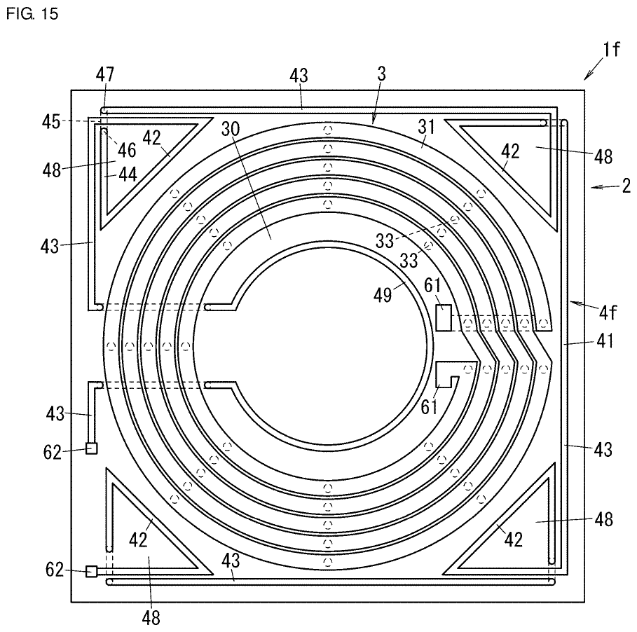

As illustrated in FIG. 15, an antenna device 1f according to a fifth preferred embodiment of the present invention is different from the antenna device 1 (see FIG. 1A) according to the first preferred embodiment in that it includes a third conductor portion 49 located in the first aperture 30 of the first coil conductor 3. In the antenna device 1f according to the fifth preferred embodiment, the same or corresponding elements as those of the antenna device 1 according to the first preferred embodiment are denoted by the same reference numerals, and description thereof will not be repeated.

As illustrated in FIG. 15, the antenna device 1f includes a second coil conductor 4f instead of the second coil conductor 4. The second coil conductor 4f includes the first conductor portion 41, the plurality of second conductor portions 42, and the third conductor portion 49. Structures and functions of the second coil conductor 4f in the fifth preferred embodiment, which are the same or substantially the same as those of the second coil conductor 4 (see FIG. 1A) in the first preferred embodiment, will not be described.

The third conductor portion 49 is provided in the first aperture 30 of the first coil conductor 3 when viewed from the first direction D1 (the winding axis direction of the first coil conductor 3). The winding axis of the third conductor portion 49 is parallel or substantially parallel to the winding axis of the first coil conductor 3.

In the second coil conductor 4f, the plurality of conductor pieces 43 of the first conductor portion 41, the plurality of second conductor portions 42, and the third conductor portion 49 are connected as follows. The plurality of conductor pieces 43, the plurality of second conductor portions 42, and the third conductor portion 49 are connected in the order of the conductor piece 43, the third conductor portion 49, the conductor piece 43, the second conductor portion 42, the conductor piece 43, the second conductor portion 42, the conductor piece 43, the second conductor portion 42, the conductor piece 43, and the second conductor portion 42.

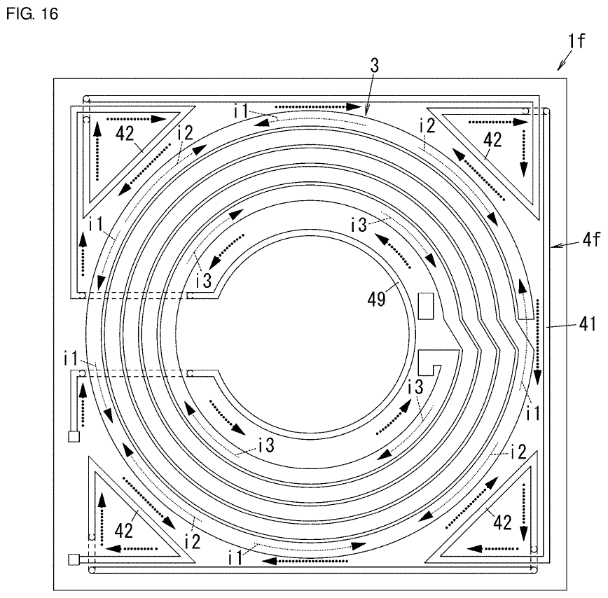

As illustrated in FIG. 16, the second coil conductor 4f is provided such that a direction of a current flowing through the first conductor portion 41 and a circulating direction of the current flowing through the third conductor portion 49 are opposite to each other when viewed from the first direction D1 (the winding axis direction of the first coil conductor 3). A third induced current i3 in the opposite direction to that of the current flowing through the third conductor portion 49 is generated in a portion of the first coil conductor 3, which is close to the third conductor portion 49 of the second coil conductor 4f. Therefore, in the first coil conductor 3, the first induced current i1 that is generated in the portions thereof, which are close to the first conductor portion 41, is canceled by the second induced current i2 that is generated in the portions thereof, which are close to the second conductor portions 42, and the third induced current i3 that is generated in the portion thereof, which is close to the third conductor portion 49. The total sum of the currents flowing through the first coil conductor 3 is thus much lower than that in the case where the third conductor portion 49 is not provided. As a result, mutual interference between the first coil conductor 3 and the second coil conductor 4f is able to be reduced.

As for applications of the antenna device 1f according to the fifth preferred embodiment, the antenna device 1f is used in the electronic apparatus 8 similar to the antenna device 1 according to the first preferred embodiment.

As described above, in the antenna device 1f according to the fifth preferred embodiment, the mutual interference between the first coil conductor 3 and the second coil conductor 4f is able to be further reduced. A gap between the first coil conductor 3 and the second coil conductor 4f is thus able to be further decreased. As a result, the antenna device 1f is able to be further reduced in size.

In each of the preferred embodiments and variations described above, although the first coil conductor 3 has the circular shape, the first coil conductor 3 is not necessarily limited to have the circular shape. The first coil conductor 3 may have an elliptical shape, a rectangular shape, a polygonal shape, or another shape, for example. For the second coil conductor 4, it is sufficient that portions of the second conductor portions 42 are close to the first coil conductor 3. The second coil conductors 42 are not limited to having the right-angled triangular shapes, but may have other triangular shapes or substantially triangular shapes, for example. When the first coil conductor 3 has the circular shape, it is more preferable that adjacent portions of the second conductor portions 42 have arc shapes along the first coil conductor 3.

In addition, in the above-described preferred embodiments and variations, although the first coil conductor portion 31 and the second coil conductor portion 32 overlap with each other in a plan view viewed from the first direction D1, it is not necessary that the first coil conductor portion 31 and the second coil conductor portion 32 overlap with each other completely. For example, by causing the first coil conductor portion 31 and the second coil conductor portion 32 to shift from each other, it is possible to control a radiation direction of the magnetic flux.

The preferred embodiments and variations described above are only portions of various preferred embodiments and variations of the present invention. In addition, as long as the advantageous effects of the present invention are able to be achieved, various changes may be made to the preferred embodiments and variations in accordance with design or the like.

The following aspects are disclosed by the preferred embodiments and variations described above.

An antenna device (1) according to a preferred embodiment of the present invention includes a first coil conductor (3) and a second coil conductor (4). The first coil conductor (3) is for a first system and has a spiral shape. The second coil conductor (4) is for a second system. The first coil conductor (3) includes a first aperture (30). The second coil conductor (4) includes a first conductor portion (41) and a second conductor portion (42). The first conductor portion (41) surrounds a formation region of the first coil conductor (3) when viewed from a winding axis direction (first direction D1) of the first coil conductor (3). The second conductor portion (42) is connected to the first conductor portion (41) and is wound so as to include a second aperture (48). At least a portion of the second conductor portion (42) is provided in an outer side portion relative to an outermost circumference of the first coil conductor (3) when viewed from the winding axis direction of the first coil conductor (3). In the second conductor portion (42), at least a portion of the second aperture (48) is provided in an outer side portion relative to the formation region of the first coil conductor (3). The second conductor portion (42) includes a portion farther from the first coil conductor (3) than the first conductor portion (41).

In an antenna device (1) according to a preferred embodiment of the present invention, the second conductor portion (42) of the second coil conductor (4) disposed in the outer side portion relative to the outermost circumference of the first coil conductor (3) is provided. The second conductor portion (42) includes the portion farther from the first coil conductor (3) than the first conductor portion (41). With this configuration, magnetic field coupling between the first coil conductor (3) and the second coil conductor (4) is able to be weakened, so that mutual interference between the first coil conductor (3) and the second coil conductor (4) is able to be reduced.

In an antenna device (1) according to a preferred embodiment of the present invention, the second coil conductor (4) is provided such that a circulating direction of a current flowing through the first conductor portion (41) about a center of gravity of the first aperture (30) and a circulating direction of a current flowing through the second conductor portion (42) about a center of gravity of the second aperture (48) are the same when viewed from the winding axis direction (first direction D1) of the first coil conductor (3).

In an antenna device (1) according to a preferred embodiment of the present invention, the second coil conductor (4) is provided such that a magnetic flux which is generated from the first conductor portion (41) surrounding the formation region of the first coil conductor (3) and a magnetic flux which is generated from the second conductor portion (42) are the same phase.

An antenna device (1) according to a preferred embodiment of the present invention further includes a magnetic member (5). At least a portion of the magnetic member (5) overlaps with the formation region of the first coil conductor (3) when viewed from the winding axis direction of the first coil conductor (3).

In an antenna device (1) according to a preferred embodiment of the present invention, the magnetic member (5) at least a portion of which overlaps with the formation region of the first coil conductor (3) is provided. With this configuration, a desired inductance is able to be obtained.

In an antenna device (1c; 1d) according to a preferred embodiment of the present invention, the magnetic member (5c; 5d) includes a portion (slit 51) which does not overlap with the second aperture (48) when viewed from the winding axis direction of the first coil conductor (3).

In an antenna device (1c; 1d) according to a preferred embodiment of the present invention, when the magnetic member (5c; 5d) does not overlap with the second aperture (48) of the second conductor portion (42), the induced current in the opposite direction, which flows through the first coil conductor (3) in the vicinity of the second conductor portion (42), is increased, so that the magnetic field coupling between the first coil conductor (3) and the second coil conductor (4) is able to be further reduced. As a result, the antenna device (1c; 1d) is able to be further reduced in size.

In an antenna device (1e) according to a preferred embodiment of the present invention, the second conductor portion (42e) of the second coil conductor (4e) includes a portion that overlaps with the first coil conductor (3) when viewed from the winding axis direction of the first coil conductor (3).

In an antenna device (1e) according to a preferred embodiment of the present invention, it is possible to reduce the degree of coupling between the first coil conductor (3) and the second coil conductor (4). Accordingly, a gap between the first coil conductor (3) and the second coil conductor (4) is able to be decreased. As a result, the antenna device (1e) is able to be further reduced in size.

In an antenna device (1f) according to a preferred embodiment of the present invention, the second coil conductor (4f) further includes a third conductor portion (49). The third conductor portion (49) is provided in the first aperture (30) of the first coil conductor (3) when viewed from the winding axis direction of the first coil conductor (3). A winding axis of the third conductor portion (49) is parallel or substantially parallel to the winding axis of the first coil conductor (3).

In an antenna device (1f) according to a preferred embodiment of the present invention, it is possible to further reduce the degree of coupling between the first coil conductor (3) and the second coil conductor (4f). Accordingly, the gap between the first coil conductor (3) and the second coil conductor (4f) is able to be further decreased. As a result, the antenna device (1f) is able to be further reduced in size.

An antenna device (1) according to a preferred embodiment of the present invention further includes a base (2). The first coil conductor (3) and the second coil conductor (4) are provided on the base (2). The second conductor portion (42) is provided at a corner portion of the base (2).

In an antenna device (1) according to a preferred embodiment of the present invention, the second conductor portion (42) is provided at a position farthest from the first coil conductor (3).

In an antenna device (1) according to a preferred embodiment of the present invention, a plurality of the second conductor portions (42) are provided.

In an antenna device (1) according to a preferred embodiment of the present invention, the plurality of second conductor portions (42) are provided at symmetrical positions.

In an antenna device (1) according to a preferred embodiment of the present invention, since the second conductor portions (42) are provided at the symmetrical positions, it is possible to improve the symmetry of antenna characteristics of the second coil conductor (4).

In an antenna device (1) according to a preferred embodiment of the present invention, the numbers of turns of the plurality of second conductor portions (42) are different from each other, in the tenth or eleventh aspect.

In an antenna device (1) according to a preferred embodiment of the present invention, the numbers of turns of the second conductor portions (42) are different from each other, so that directivity of the antenna characteristics of the second coil conductor (4) is able to be changed. Influences of a metal component are able to be avoided if there is the metal component around it.

In an antenna device (1) according to a preferred embodiment of the present invention, areas of formation regions of the plurality of second conductor portions (42) are different from each other.

In an antenna device (1) according to a preferred embodiment of the present invention, the areas of the formation regions of the second conductor portions (42) are different from each other, so that the directivity of the antenna characteristics of the second coil conductor (4) is able to be changed.

In an antenna device (1) according to a preferred embodiment of the present invention, areas of formation regions of the plurality of second conductor portions (42) are equal or substantially equal to each other.

With an antenna device (1) according to a preferred embodiment of the present invention, magnetic field distribution is able to be made symmetrical.

In an antenna device (1) according to a preferred embodiment of the present invention, the first coil conductor (3) is a coil for wireless charging, and the second coil conductor (4) is a coil for proximity communication.

In an antenna device (1) according to a preferred embodiment of the present invention, a frequency band of the first system is a frequency band included in an LF band to an HF band.

A communication system (7) according to a preferred embodiment of the present invention includes an antenna device according to a preferred embodiment of the present invention, a first system circuit (71), and a second system circuit (72).

An electronic apparatus (8) according to a preferred embodiment of the present invention includes an antenna device (1) according to a preferred embodiment of the present invention, a circuit substrate (81), and a housing (82). The circuit substrate (81) includes a system circuit to operate the antenna device (1). The housing (82) accommodates the antenna device (1) and the circuit substrate (81).

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An antenna device comprising:
a first coil conductor that is for a first system and has a spiral shape; and
a second coil conductor that is for a second system; wherein
the first coil conductor includes a first aperture;
the second coil conductor includes:
a first conductor portion surrounding a formation region of the first coil conductor when viewed from a winding axis direction of the first coil conductor; and
a second conductor portion connected to the first conductor portion and wound so as to include a second aperture, at least a portion of which is disposed in an outer side portion relative to an outermost circumference of the first coil conductor when viewed from the winding axis direction of the first coil conductor, and in which at least a portion of the second aperture is disposed in an outer side portion relative to the formation region of the first coil conductor; and
the second conductor portion includes a portion farther from the first coil conductor than the first conductor portion.

2. The antenna device according to claim 1, wherein the second coil conductor is provided such that a circulating direction of a current flowing through the first conductor portion about a center of gravity of the first aperture and a circulating direction of a current flowing through the second conductor portion about a center of gravity of the second aperture are the same when viewed from the winding axis direction of the first coil conductor.

3. The antenna device according to claim 1, wherein the second coil conductor is provided such that a magnetic flux generated from the first conductor portion surrounding the formation region of the first coil conductor and a magnetic flux generated from the second conductor portion are in a same phase.

4. The antenna device according to claim 1, further including a magnetic member at least a portion of which overlaps with the formation region of the first coil conductor when viewed from the winding axis direction of the first coil conductor.

5. The antenna device according to claim 4, wherein the magnetic member includes a portion that does not overlap with the second aperture when viewed from the winding axis direction of the first coil conductor.

6. The antenna device according to claim 1, wherein the second conductor portion of the second coil conductor includes a portion that overlaps with the first coil conductor when viewed from the winding axis direction of the first coil conductor.

7. The antenna device according to claim 1, wherein
the second coil conductor further includes a third conductor portion provided in the first aperture of the first coil conductor when viewed from the winding axis direction of the first coil conductor; and
a winding axis of the third conductor portion is parallel or substantially parallel to the winding axis of the first coil conductor.

8. The antenna device according to claim 1, further comprising:
a base on which the first coil conductor and the second coil conductor are provided; wherein
the second conductor portion is provided at a corner portion of the base.

9. The antenna device according to claim 1, wherein the second conductor portion is provided at a position farthest from the first coil conductor.

10. The antenna device according to claim 1, wherein a plurality of the second conductor portions are provided.

11. The antenna device according to claim 10, wherein the plurality of second conductor portions are provided at symmetrical positions.

12. The antenna device according to claim 10, wherein numbers of turns of the plurality of second conductor portions are different from each other.

13. The antenna device according to claim 10, wherein areas of formation regions of the plurality of second conductor portions are different from each other.

14. The antenna device according to claim 10, wherein areas of formation regions of the plurality of second conductor portions are equal or substantially equal to each other.

15. The antenna device according to claim 1, wherein
the first coil conductor is a coil for wireless charging; and
the second coil conductor is a coil for proximity wireless communication.

16. The antenna device according to claim 1, wherein a frequency band of the first system is a frequency band included in an LF band to an HF band.

17. A communication system comprising:
the antenna device according to claim 1;
a circuit for the first system; and
a circuit for the second system.

18. The communication system according to claim 17, wherein the second coil conductor is provided such that a circulating direction of a current flowing through the first conductor portion about a center of gravity of the first aperture and a circulating direction of a current flowing through the second conductor portion about a center of gravity of the second aperture are the same when viewed from the winding axis direction of the first coil conductor.

19. An electronic apparatus comprising:
the antenna device according to claim 1;
a circuit substrate including a system circuit to operate the antenna device; and
a housing that accommodates the antenna device and the circuit substrate.

20. The electronic apparatus according to claim 19, wherein the second coil conductor is provided such that a circulating direction of a current flowing through the first conductor portion about a center of gravity of the first aperture and a circulating direction of a current flowing through the second conductor portion about a center of gravity of the second aperture are the same when viewed from the winding axis direction of the first coil conductor.
